(19) United States
(12) Patent Application Publication
(10) Pub. No.: US 2009/0187416 A1
(43) Pub. Date: Jul. 23, 2009

(54) Fuel Station Apparatus and Method for Utilizing the Same

(75) Inventors: Oliver F. Baer, Grosse Pointe, MI (US); David L. Shaw, Harrison Township, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Clean Emission Fluids, Inc., Grosse Pointe, MI (US)

(21) Appl. No.: 12/354,998

(22) Filed: Jan. 16, 2009

Related U.S. Application Data
(60) Provisional application No. 61/021,824, filed on Jan. 17, 2008.

(51) Int. Cl. G06Q 99/00; B65B 1/04; G06F 7/06; G06F 17/30

(52) U.S. Cl. 705/1; 141/105; 141/1; 707/3; 707/9

(57) ABSTRACT

An apparatus is disclosed. The apparatus includes a housing, one or more fluid tanks disposed within the housing, a fluid modification network in fluid communication with the one or more fluid tanks, one or more dispenser nozzles each including a hose that are connected to and in fluid communication with the fluid modification network, and a controller connected to fluid modification network. A method for operating an apparatus is also disclosed. A method associated with the operation of an apparatus is also disclosed.

### RELATED APPLICATION

This application claims the benefit of U.S. provisional patent application Ser. No. 61/021,824 filed on Jan. 17, 2008.

### FIELD OF THE INVENTION

The disclosure relates to a fuel station apparatus and to a method for utilizing the same.

### DESCRIPTION OF THE RELATED ART

It is anticipated that most if not all vehicles will consume a blend of fossil fuels and “green” fuels (e.g. bio-fuels or the like) in the immediate future (hereinafter, collectively referred to as “alternative fuels” or “alternative fuel blends”). Therefore, a need exists in the art for the development of a novel fuel station apparatus and method for utilizing the same that permits a consumer to have access to alternative fuel blends.

### BRIEF DESCRIPTION OF THE DRAWINGS

The disclosure will now be described, by way of example, with reference to the accompanying drawings, in which:

FIG. 1 is a perspective view of a fuel station apparatus in accordance with an embodiment of the invention;

FIG. 2 is a plan view of components comprising a fuel station apparatus in accordance with an embodiment of the invention;

FIG. 3 is a side view of a vehicle including a fuel station apparatus in accordance with an embodiment of the invention;

FIG. 4 is a view of a fluid blending network of a fuel station apparatus in accordance with an embodiment of the invention;

FIG. 5 is a view of a communication network associated with the fuel station apparatus in accordance with an embodiment of the invention;

FIG. 6 is a logic flow diagram for operating the fuel station apparatus in accordance with an exemplary embodiment of the invention;

FIGS. 7A-7B is a logic flow diagram for operating the fuels station apparatus in accordance with an exemplary embodiment of the invention;

FIG. 8 is a logic flow diagram for operating the fuel station apparatus in accordance with an exemplary embodiment of the invention;

FIG. 9 is a logic flow diagram associated with the operation of the fuel station apparatus in accordance with an exemplary embodiment of the invention;

FIG. 10 is a logic flow diagram associated with the operation of the fuel station apparatus in accordance with an exemplary embodiment of the invention;

FIG. 11 is a logic flow diagram associated with the operation of the fuel station apparatus in accordance with an exemplary embodiment of the invention;

FIG. 12 is a logic flow diagram associated with the operation of the fuel station apparatus in accordance with an exemplary embodiment of the invention; and

FIG. 13 is a logic flow diagram associated with the operation of the fuel station apparatus in accordance with an exemplary embodiment of the invention.

### DETAILED DESCRIPTION OF THE INVENTION

The Figures illustrate an exemplary embodiment of a novel fuel station apparatus and method for utilizing the same in accordance with an embodiment of the invention. Based on the foregoing, it is to be generally understood that the nomenclature used herein is simply for convenience and the terms used to describe the invention should be given the broadest meaning by one of ordinary skill in the art.

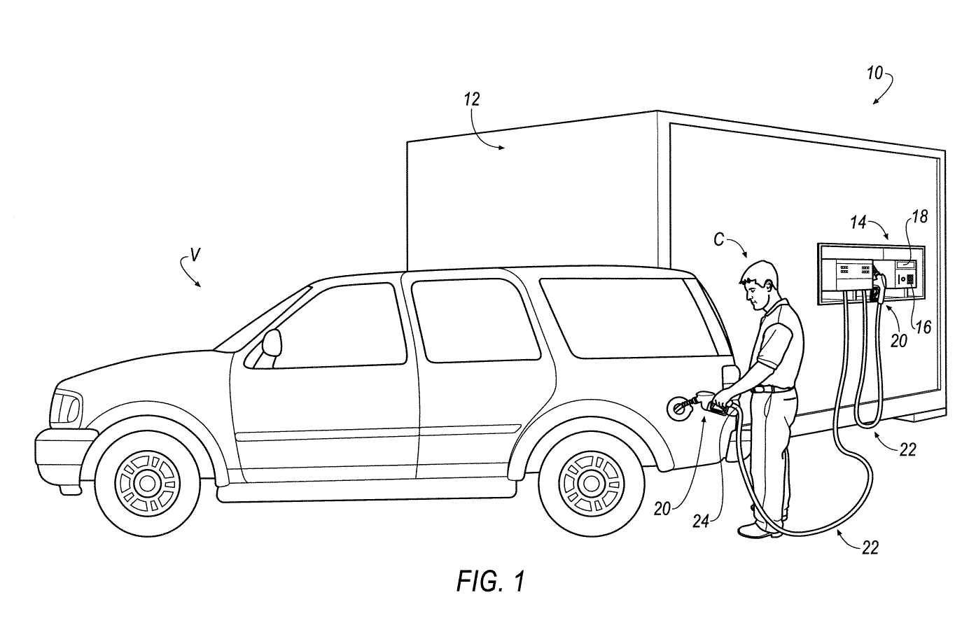

Referring to FIG. 1, a fuel station apparatus is shown generally at 10 in accordance with an embodiment of the invention. In an embodiment, the fuel station apparatus 10 may dispense one or more alternative fuels. It will be appreciated, however, that the fuel station apparatus 10 is not limited to providing one or more fuels and that the fuel station apparatus 10 may also provide one or more fluids that does not define a fuel (such as an exhaust additive, or the like). Accordingly, it will be appreciated that the fuel station apparatus 10 may provide any desirable fluid used in the operation of a vehicle.

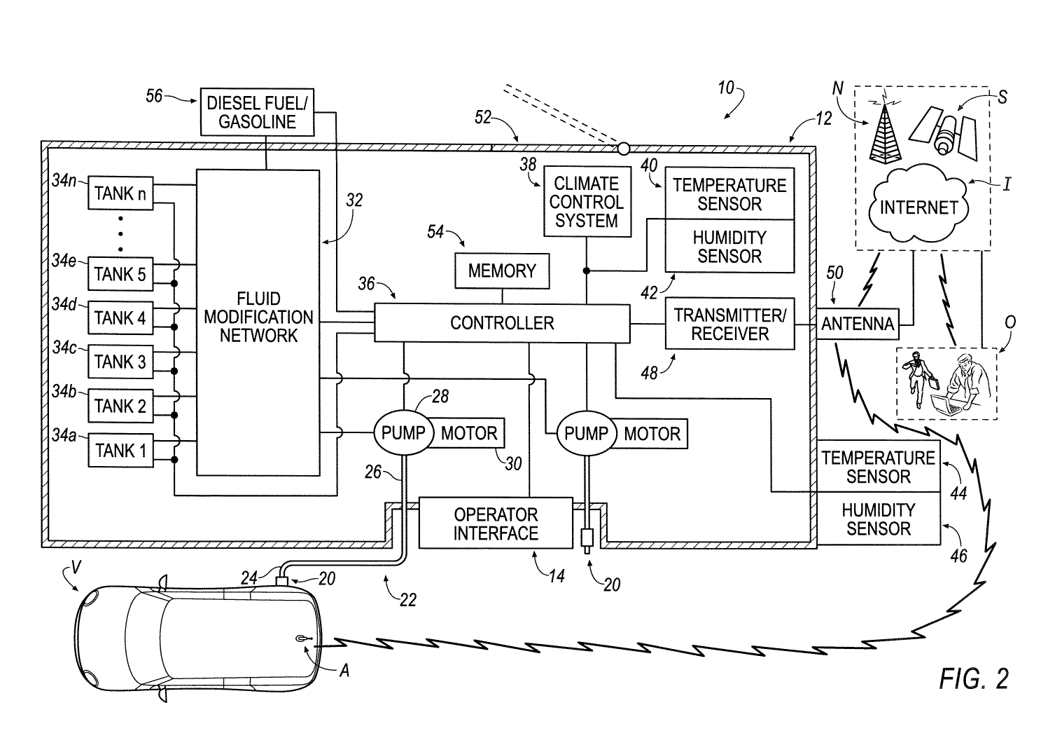

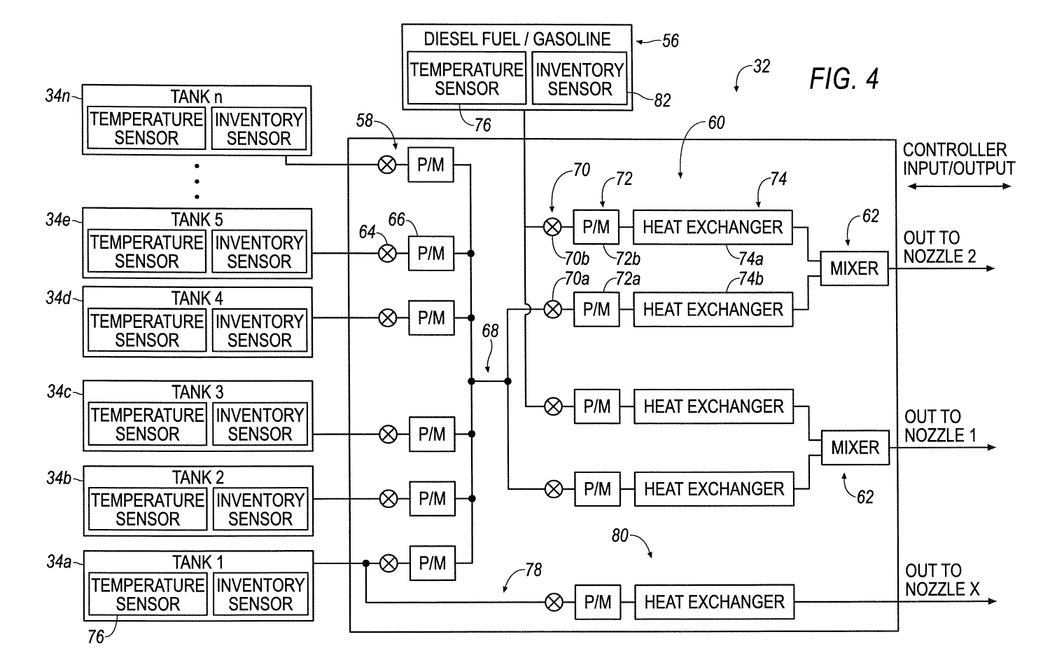

In an embodiment, the fuel station apparatus 10 may include structure (see, e.g., FIGS. 2 and 4) that selectively blends a plurality of fluids/ “ingredients” according to one or more “recipes” to permit the dispensing of the one or more alternative fuels or the like by the fuel station apparatus 10. In an embodiment, the one or more alternative fuels provided by the fuel station apparatus 10 may increase the operating efficiency or the operating cost of a vehicle, V, when compared to conventional, non-alternative fuels (e.g. diesel, petrol/gasoline or the like). Further, in an embodiment, the one or more alternative fuels may permit operation of the vehicle, V, to be in compliance with one or more governmental regulations that may, for example, be aimed at protecting the environment. These and other features associated with embodiments of the invention will be explained in the foregoing disclosure.

In an embodiment, the one or more alternative fuels provided by the fuel station apparatus 10 may include, for example, a “green” fuel. In an embodiment, a genus of “green” fuels may include, for example, one or more bio-fuels. In an embodiment, one or more species of bio-fuels provided by the fuel station apparatus 10 may include, but is not limited to: bio-diesel, bio-alcohol or the like. Although an embodiment of the invention discussed in the foregoing disclosure refers to the dispensing of a bio-fuel, it will be appreciated that the fuel station apparatus 10 is not limited to dispensing bio-fuels, and, as such, the fuel station apparatus 10 may dispense, in an embodiment, any type of fuel, including, for example, petrol/gasoline, diesel or the like.

Further, in an embodiment, it will be appreciated that the fuel station apparatus 10 is not limited to dispensing consumables (e.g. a fuel), and, as such, it will be appreciated that the fuel station apparatus may dispense other liquids, such as, for example, glycol, motor oil or the like. Yet even further, in an embodiment, it will be appreciated that although the fuel station apparatus 10 has been described above to dispense a fluid that may be in a liquid form, it will be appreciated that the fuel station apparatus 10 is not limited to dispensing a fluid in one particular form and that the fuel station apparatus 10 may dispense one or more fluids in one or more forms that include, but is not limited to: liquids, gases, powders, solids, non-solids or the like.

In an embodiment, as seen in FIG. 1-2, the one or more alternative fuels may be dispensed into a fuel tank of a vehicle, V. In an embodiment, the vehicle, V, may include a prime mover that is adapted to consume the one or more alternative fuels. In an embodiment, the vehicle, V, may include but is not limited to: a passenger car, truck, bus, tractor-trailer, boat, railway car, airplane, tractor, plow, bulldozer or the like.

Further, in an embodiment, it will be appreciated that the one or more fluids provided by the fuel station apparatus 10 is not limited to being dispensed into one or more tanks of a vehicle, V. Accordingly, it will be appreciated that the fuel station apparatus 10 may be utilized to dispense one or more fluids into one or more tanks of any desirable body, such as, for example, a non-vehicular body that includes but is not limited to motorized or non-motorized equipment. In an embodiment, motorized or non-motorized equipment may include, for example, a generator, a lawn-mower, a rotary tiller, a snow blower/thrower or the like.

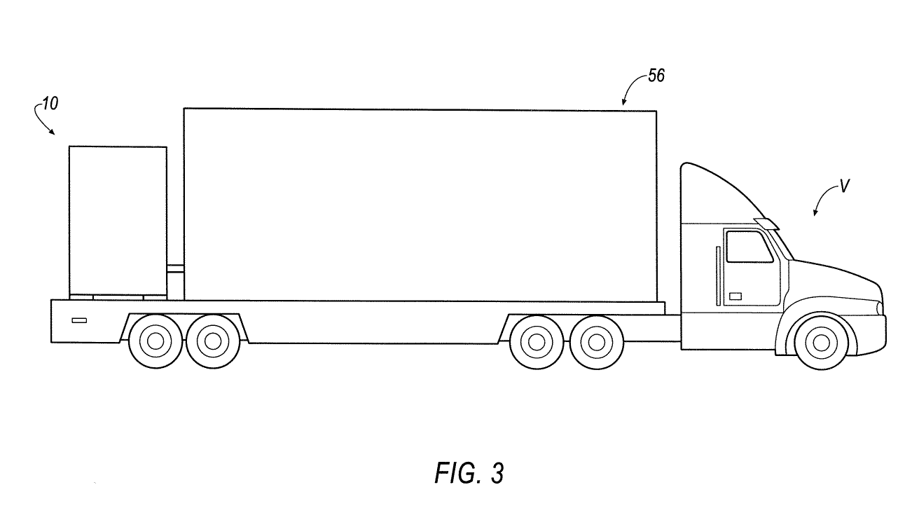

In an embodiment, as seen in FIG. 1, the fuel station apparatus 10 may be immobile such that the vehicle, V, may be moved proximate the fuel station apparatus 10. Alternatively, as seen in FIG. 3, the fuel station apparatus 10 may be mobile such that the fuel station apparatus 10 may be located on a tractor-trailer fuel tanker vehicle, V, that may be moved, for example, proximate a passenger vehicle, V.

Accordingly, in an embodiment, if the fuel station apparatus 10 is immobile, the fuel station apparatus 10 may be located at, for example, a conventional gas station, truck stop/rest area, convenience store parking lot, shopping center parking lot, a municipality parking lot (e.g., proximate a police station, a department of public services building, city hall or the like), upon the side/shoulder of a highway, boat dock or the like. Alternatively, in an embodiment, as seen in FIG. 3, if the fuel station apparatus 10 is mobile, the fuel station apparatus 10 may be located on, for example, a mobile transporting vehicle, such as, for example, a tractor-trailer fuel tank vehicle, V, or, alternatively, a re-fueling airplane in order to re-fuel, for example, another airplane that is in flight. Although several immobile/mobile applications are listed above, it will be appreciated that the invention is not limited to one of the above applications and that any desirable immobile/mobile application may be practiced, as desired.

Referring to FIG. 1-2, according to an embodiment of the invention, the fuel station apparatus 10 is shown to include several panels that define a housing 12. It will be appreciated that although the housing 12 is illustrated to be disposed upon a support surface/“above ground,” it will be appreciated that a portion of the housing 12 or all of the housing 12 may be disposed below a support surface/“below ground.”

Connected to one of the panels of the housing 12 is an operator interface 14 that may include, for example, input keys/buttons 16, a display screen 18 or the like. Located proximate the operator interface 14 may be one or more fuel dispenser nozzles 20 that may be interfaced with the vehicle, V.

A first end 24 of a hose 22 may be attached to and extend from each of the one or more fuel dispenser nozzles 20. The hose 22 extends into the housing 12 and terminates at a second end 26 (see, e.g., FIG. 2) for permitting the movement of the one or more alternative fuel blends from the fuel station apparatus 10 to the vehicle, V.

Referring to FIG. 2, the second end 26 of the hose 22 may be connected to a pump 28. The pump 28 may be connected to a motor 30 that operates the pump 28. The pump 28 may be connected to a fluid modification network 32 that receives one or more fluids from one or more tanks 34a-34n.

The fuel station apparatus 10 may also include a controller 36. The controller 36 may be connected to the pump 28, motor 30, fluid modification network 32 and each of the one or more tanks 34a-34n. Further, the controller 36 may be connected to one or more of a climate control system 38, a first temperature sensor 40, a first humidity sensor 42, a second temperature sensor 44, a second humidity sensor 46, and a transmitter/receiver 48 that is connected to an antenna 50.

In an embodiment, as seen in FIG. 2, at least one of the panels comprising the housing 12 may define a door 52. When moved to an open position, the door 52 may permit human access any of the components 28-50. It will be appreciated that access to any of the components 28-50 may be needed for inspection, maintenance or the like.

Although the fuel station apparatus 10 has been described above to include structure that is identified at reference numerals 12-50, it will be appreciated that the fuel station apparatus 10 is not limited to including the structure 12-50 discussed above. For example, the fuel station apparatus 10 may include additional structure that performs one or more functions, such as, for example, a system for maintaining the hoses 22 at a predetermined temperature to prevent, for example, the hoses 22 from freezing or over-heating. In an embodiment, to prevent the hoses 22 from freezing, the housing 12 may define a closet with a movable door to permit access to the one or more hoses 22; accordingly the closet and movable door may provide a climate-controlled sub-housing that renders the one or more hoses 22 in an operable condition.

In an embodiment, the controller 36 may include a digital computer that is programmed to operate the fuel station apparatus 10 by sending/receiving information to/from any numbers of persons and/or components. In an embodiment, the controller 36 may send/receive information to/from a consumer, C (see, e.g., FIG. 1), by way of the operator interface 14. In an embodiment, the controller 36 may send/receive information to/from the vehicle, V, by way of a vehicular antenna, A (see, e.g., FIG. 2), radio frequency identification (RFID) antenna or the like. In an embodiment, the controller 36 may locally send/receive information to/from an owner, lessee or maintenance person at the operator interface 14 and/or the climate control system 38. In an embodiment, the controller 36 may remotely send/receive information to/from the owner, O (see, e.g., FIG. 2), lessee or maintenance person at the antenna 50 by way of one or more of the Internet, I, a cellular network, N, a satellite network, S, or the like. In an alternative embodiment, rather than, or, in addition to sending/receiving information, the controller 36 may pre-programmed with a set of operating protocols/operating instructions. It will be appreciated that although several communication methodologies are described above, it will be appreciated that the invention is not limited to the above-described methodologies and that any desirable methodology may be employed as desired.

As mentioned above, the fuel station apparatus 10 may selectively blend a plurality of fluids/“ingredients” according to one or more “recipes.” In an embodiment, the “ingredients” may include one or more fluids that are stored, respectively, within each of the one or more tanks 34a-34n. The one or more “recipes” may be stored within, for example, memory 54 that is connected to the controller 36.

In an embodiment, the “ingredients” stored in each of the one or more tanks 34a-34n may include, but is not limited to: a pre-manufactured bio-fuel, a diesel emissions fluid (DEF) (e.g., an aqueous urea solution/ADBLUE®/AUS32 or the like), a non-taxable off-road diesel/red diesel, a biological feedstock, an oil/fat feedstock, a biologically-produced alcohol, a fuel additive (e.g., a knocks-reducing additive), sodium hydroxide, methanol, ethanol and the like. In an embodiment, if a bio-diesel is stored in the fuel station apparatus 10, one or more of a biological feedstock, an oil/fat feedstock material or the like may be rendered from, but is not limited to: animal fats, vegetable oils, reclaimed grease, soy, rapeseed, jatropha, mahua, mustard, flax, sunflower, palm oil, hemp, field pennycress, algae or the like. In an embodiment, if a bio-alcohol fuel is being stored in the fuel station apparatus 10, the biologically-produced alcohol may include an alcohol fuel produced by the fermentation of sugars derived from, but not limited to: wheat, corn, sugar beets, sugar cane, molasses or the like.

In an embodiment, the fuel station apparatus 10 may also include, or, alternatively, be connected to one or more external tanks 56. The one or more external tanks 56 may include one or more additional ingredients such as, for example, a diesel fuel and/or gasoline. It will be appreciated, however, that the one or more tanks 56 containing a diesel fuel and/or gasoline may not necessarily be located outside of/to the exterior of the housing 12, but rather, may be located inside of/within the interior of the housing 12.

In an embodiment, the one or more tanks 34a-34n, 56 may be refilled, replaced or exchanged such that the fuel station apparatus 10 is not limited to containing a particular fluid/“ingredient.” The refilling, replacing or exchanging of the one or more tanks 34a-34n may be conducted by way of, for example, gaining access the one or more tanks 34a-34n by entering the housing 12 through the door 52.

In an embodiment, the one or more tanks 34a-34n, 56 may include structure that includes, for example, one or more layers having one or more qualities that permits the one or more tanks 34a-34n, 56 to provide the function of optimally storing one or more fluids. For example, the one or more tanks 34a-34n may store a corrosive, non fuel fluid (e.g. AD-BLUE®) or non-fossil-fuel fuel (e.g. a bio-feedstock material), and, as such, in an embodiment, the one or more tanks 34a-34n may include a plastic material body/layer (e.g., including high density polyethylene (HDPE)), a steel body/layer or a stainless steel body/layer (e.g., SS304, SS316 or the like) that may or may not include an epoxy-glass resin inner boundary/liner layer that resists the leaching/penetration of the corrosive, non-fossil fuel fluid into the body/layer of the tank 34a-34n, which may otherwise result in the non-optimal performance of the one or more tanks 34a-34n. Further, in an embodiment, if the one or more tanks 34a-34n, 56 stores a fossil-fuel fuel (e.g., gasoline), the one or more tanks 34a,-34n, 56 may include, for example, one or more layers that may include, for example, a sulfur powder material blended with a plastic material to form a body/layer, or, may, for example, include a plastic body/layer that may be gaseously-sulfonated in order to resist the escaping of hydrocarbons from the fossil fuel fluid stored in the one or more tanks 34a-34n, 56 to atmosphere. Accordingly, it will be appreciated that the one or more tanks 34a-34n, 56 may be adapted to include any desirable structure or quality that permits the one or more tanks 34a-34n, 56 to store one or more fluids that includes, for example, a fossil-fuel, a non-fossil-fuel fuel, or a non-fuel fluid.

In an embodiment, the memory 54 may be updated in order to add, delete or revise the one or more “recipes.” In an embodiment, the memory 54 may be updated by locally programming the memory 54 via gaining access to, for example, the operator interface 14. In an embodiment, the memory 54 may be updated by remotely programming the memory 54 via the antenna 50 by way of one or more of the Internet, I, cellular network, N, satellite network, S, or the like.

In operation, when a fueling procedure is about to be conducted, the controller 36 may refer to the “recipe” (i.e., the “recipe” contains instructions for the controller 36) in order to determine, for example: 1) which of the one or more tanks 34a-34n, 56 should be accessed, 2) how much (e.g. by volume or by mass) of the one or more fluids should be drawn from the one or more tanks 34a-34n, 56 and 3) what, if any, modification to the one or more fluid's temperature should be executed. In an embodiment, the controller 36 may execute such steps provided by the “recipe” by communicating with the fluid modification network 32.

Referring to FIG. 4, the fluid modification network 32 may include a plurality of upstream fluid handing portions 58 that are in fluid communication with a plurality of downstream fluid handling portions 60. In an embodiment, the plurality of upstream fluid handling portions 58 are arranged in fluid communication with each of the one or more tanks 34a-34n. In an embodiment, the plurality of downstream fluid handling portions 60 are arranged in fluid communication with one or more fluid mixers/mixing devices 62. The one or more mixing devices 62 are arranged in fluid communication with the fuel dispenser nozzles 20 by way of one or more pumps 28 and hoses 22.

In an embodiment, each upstream fluid handling portion of the plurality of upstream fluid handling portions 58 may include a valve 64 that is in fluid communication with a pump-motor device 66. With reference to the “recipe,” one or more fluids may be called for, and, accordingly, the controller 36 may provide an instruction to one or more valves 64 in order to move the one or more of the valves 64 from a closed orientation to an open orientation in order to gain access to the called-out one or more fluids located within the one or more tanks 34a-34n.

Subsequently, the controller 36 may then instruct the pump-motor device 66 (that is associated with each valve 64 that is moved to the opened orientation) to draw the called-out fluid from the associated tank 34a-34n. Further, it will be appreciated that the controller 36 may control the rate that the fluid is drawn from a particular tank 34a-34n by selectively controlling the speed of the motor of the pump-motor device 66. Upon drawing the one or more fluids out of the one or more tanks 34a-34n, the one or more fluids are moved downstream by the pump-motor device 66 to a fluid integrating conduit/branch 68.

In an embodiment, each downstream fluid handling portion of the plurality of downstream fluid handling portions 60 includes a pair of valves 70 a pair of pump-motor devices 72 and a pair of heat exchangers 74. In an embodiment, each pair of heat exchangers 74 are in communication with the one or more fluids mixers/mixing devices 62.

In an embodiment, a first valve 70a of the pair of valves 70 is in fluid communication with the fluid conduit/fluid integrating branch 68. In an embodiment, the first valve 70a is also in fluid communication with a first pump-motor device 72a of the pair of pump-motor devices 72. In an embodiment, the first pump-motor device 72a is also in fluid communication with a first heat exchanger 74a of the pair of heat exchangers 74.

In an embodiment, a second valve 70b of the pair of valves 70 is in fluid communication with the one or more external tanks 56 containing the diesel fuel/gasoline. In an embodiment, the second valve 70b is also in fluid communication with a second pump-motor device 72b of the pair of pump-motor devices 72. In an embodiment, the second pump-motor device 72b is also in fluid communication with a second heat exchanger 74b of the pair of heat exchangers 74.

With reference to the “recipe,” when a consumer, C, selects one of the one or more fuel dispenser nozzles 20, the one or more fluids drawn into the fluid conduit/fluid integrating branch 68 may result in the controller 36 providing an instruction to one of the pair of valves 70 in order to move the one pair of valves 70 from a closed orientation to an open orientation in order to gain access to the fluid in the fluid conduit/fluid integrating branch 68 and the one or more external tanks 56. Subsequently, the controller 36 may then instruct the pair of pump-motor devices 72 to draw the fluid from the fluid conduit/fluid integrating branch 68 and the one or more external tanks 56 and through the pair of heat exchangers 74.

In some circumstances, temperature modification of the fluid may be necessary to ensure that the fuel station apparatus 10 delivers an accurately calibrated and sufficiently mixed amount/quantity of fuel due to the fact that some fluids may contract or expand when stored at/subjected to different ambient temperatures. Further, in some circumstances, during the manufacture of a bio-fuel that includes several fluids, if the temperature of each fluid is not brought to the appropriate level, the combined fluids may otherwise resist proper integration/blending, which may ultimately render an inferior end product/alternative fuel.

Accordingly, in an embodiment, prior to drawing the fluid through the pair of heat exchangers 74, the controller 36 may determine the temperature of the fluid within each of the one or more tanks 34a-34n, 56. In an embodiment, each of the one or more tanks 34a-34n, 56 may include a temperature sensor 76 that may provide the temperature of the fluid to the controller 36. Accordingly, when the controller 36 is provided with the temperature of each fluid, the controller 36 may then send an instruction to one or more of the first and second heat exchangers 74a, 74b of the pair of heat exchangers 74 in order to permit the modification of the temperature of the one or more fluids as the one or more fluids are directed through the downstream fluid handling portion 60.

Upon passing the fluid through the pair of heat exchangers 74, the fluid may be passed through the fluid mixer/mixing device 62. Functionally, the fluid mixer/mixing device 62 mixes the fluid from the fluid integrating branch 68 and the one or more external tanks 56 in order to create an appropriate blending that results in the local, on-site dispensing of a bio-fuel (e.g., bio-diesel, bio-alcohol or the like) at the fuel station apparatus 10. The bio-fuel may then be drawn further downstream from the mixing device 62 by the pump 28 such that the bio-fuel may be communicated through the hose 22 and out of the fuel dispenser nozzle 20 into the fuel tank of the vehicle, V.

In an embodiment, it will be appreciated that the fuel station apparatus 10 may provide one or more fluids that may not be mixed with another fluid (i.e. dispensed as stored without blending with another fluid). As such, it will be appreciated that the fluid modification network 32 may include a fluid-flow path that does not mix a plurality of fluids, but rather, draws fluid directly from one of the one or more tanks 34a-34n. Accordingly, as shown in FIG. 4, a dedicated dispenser nozzle (e.g. “Nozzle X”) may provide a fluid directly from one of the one or more fluid tanks 34a-34n that is free from being soiled/cross-contaminated with other fluids from other tanks 34a-34n, 56 of the fluid station apparatus 10.

In an embodiment, the fluid provided by the dedicated dispenser nozzle may include, for example, a DEF. A DEF, such as ADBLUE®/AUS32 is not a fuel or fuel additive, but rather, is provided into a separate tank associated with the vehicle such that the fluid is directed into the exhaust system of the vehicle for the purpose of reducing emissions of oxides of nitrogen from the exhaust of diesel vehicles. It will be appreciated however, that the fluid distributed by the dedicated dispenser nozzle may include a fuel, and as such, it will be appreciated that in some circumstances, the fluid associated with a tank (e.g., fluid tank 34a) may be distributed by a dedicated nozzle, but, also, still be permitted to be mixed with the other fluids associated with the remaining tanks (e.g., tanks 34b-34n, 56).

Accordingly, in an embodiment, the fluid tank 34a may include an isolated fluid branch 78 that is in direct fluid communication with an isolated downstream fluid handling portion 80 that provides fluid to the dedicated fuel dispenser nozzle. As illustrated, it will be appreciated that such a configuration may be in communication with, or, alternatively, bypass an upstream fluid handling portion as discussed above. Further, the isolated downstream fluid handling portion 80 does not include a pair of fluid branches, but rather, a single fluid branch due to the lacking of mixing step, for example, with a diesel or gasoline ingredient from the tank 56.

Referring back to FIG. 2, in an embodiment, the first temperature sensor 40 and the first humidity sensor 42 may be utilized to sense the environmental conditions (i.e., the temperature, humidity, barometric pressure, dew point, etc) within the housing 12 whereas the second temperature sensor 44 and the second humidity sensor 46 may sense the environmental conditions exterior of the housing 12.

In an embodiment, the first temperature sensor 40 and the first humidity sensor 42 may communicate with one or more of the climate control system 38 and controller 36 in order to monitor, maintain and/or manipulate the environmental conditions within the housing 12 in an optimal state in order to maintain the integrity of the fluids stored within the one or more tanks 34a-34n. In an embodiment, if, for example the fuel station apparatus 10 is located in the south-western area of America where the temperature conditions may be relatively hot in the summer months, the “shelf life”/integrity of a fluid, such as DEF, may be compromised; accordingly, by monitoring and manipulating the environmental conditions within the housing 12, the performance of the fuel station apparatus 10 may be optimized.

In an embodiment, the second temperature sensor 44 and the second humidity sensor 46 may be utilized to communicate external environmental conditions to the controller 36 relative the housing 12. In an embodiment, the external environmental conditions may be useful in assisting the controller 36 with providing a suggestion of an optimal blend of an alternative fuel to the consumer, C, as will be described herein.

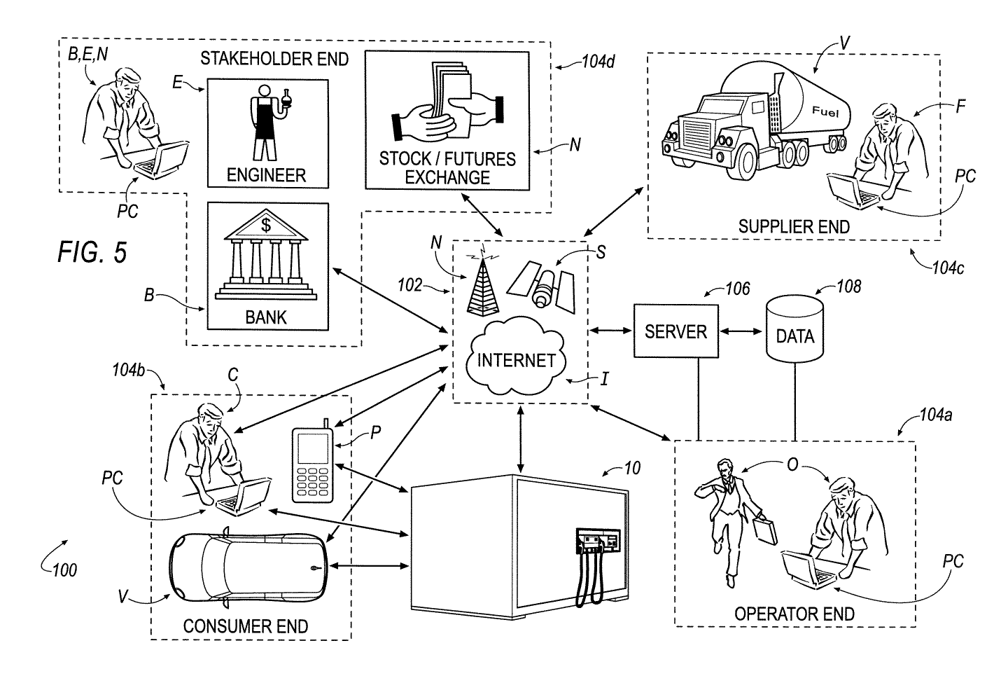

Referring now to FIG. 5, a communication network associated with the fuel station apparatus 10 is shown generally at 100 in accordance with an embodiment of the invention. In an embodiment, the communication network 100 includes one or more communication service provides, which is shown generally at 102. The one or more communication service providers 102 may utilize a variety of communication platforms that include, but is not limited to: the Internet, I, a cellular network, N, a satellite network, S, or the like, but may also include, for example, hand-delivery (e.g. “snail-mail”), personal, face-to-face communication, or the like. It will be appreciated that the one or more communication service providers 102 may send communications wirelessly, or, alternatively, over a hard-wired connection.

In an embodiment, the communication network 100 may generally include a plurality of users. In an embodiment, the users may be located at “ends” of the communication network 100, which are shown generally at 104a-104d. In an embodiment, a first end of the communication network 100 may include an operator end 104a, which may represent one or more owners/operators, O, of the fuel station apparatus 10 as well as any data, proprietary software and the like that is associated with the fuel station apparatus 10. Further, although one fuel station apparatus 10 is shown at FIG. 5, it will be appreciated that the communication network 100 may communication with a plurality of fuel station apparatuses 10 that may be owned/operated by the one or more owners/operators, O.

In an embodiment, another end of the communication network 100 may include a consumer end 104b. It will be appreciated that the consumer end 104b is not limited to a specific range, distance or proximity relative the physical location of the fuel station apparatus 10. For example, the consumer end 104b may include a consumer, C, and/or vehicle, V, located within close proximity to the fuel station apparatus 10 such that one or more of the consumer, C, and vehicle, V, may communicate directly (e.g., by pressing the buttons/keys 16) with fuel station apparatus 10, or, alternatively, indirectly (e.g., by using an antenna, A, of the vehicle) with the fuel station apparatus 10.

In another embodiment, the consumer end 104b may also include a portable communication device, P (e.g., an IPHONE®, BLACKBERRY® or the like), personal computer, PC (e.g. a desktop home computer, a laptop computer, an communication-enabled entertainment device such as a BLU-RAY® player, PLAYSTATION®), or the like that is operated by the consumer, C, and/or an agent (not shown) of the consumer, C. In an embodiment, the portable communication device, P, and/or the personal computer, PC, may be located proximate the fuel station apparatus 10, however, it will be appreciated that the portable communication device, P, and/or personal computer, PC, may be located remotely from the physical location of the fuel station apparatus 10. Accordingly, it will be appreciated that the consumer end 104b is not limited by physical distance relative the fuel station apparatus 10 when utilizing the communication network 100.

In an embodiment, another end of the communication network 100 may include a supplier end 104c. In an embodiment, the supplier located at the supplier end 104c may be represented by a fluid supplier, such as, for example, a fuel supplier, F. In an embodiment, if the supplier is a fuel supplier, F, the fuel supplier end 104c may include, but is not limited to a vehicle, V, such as, for example, a tractor-trailer that hauls alternative fuels, fossil fuels, bio-fuels, exhaust additives, and the like. Further, in an embodiment, it will be appreciated that one or more of the vehicle, V, and fuel supplier, F, may communicate with the communication network 100 by way of one or more of a personal computer, PC, portable communication device, P, or the like.

Regarding the supplier end 104, it will be appreciated, however, that the supplier end 104c is not limited to include a fuel suppler, F. Accordingly, the supplier end 104c may include, but is not limited to a supplier of a non-fuel fluid, such as for example, ADBLUE®/AUS32. Yet even further, it will be appreciated that the supplier end 104c is not limited to a supplier of a fluid, but rather, a supplier of services, such as, for example, a maintenance person that may be contracted to repair, for example, the climate control system 38.

In an embodiment, another end of the communication network 100 may include a stakeholder end 104d. The stakeholder end 104d may include communication devices described above, such as, for example, a personal computer, PC, a portable communication device, P, or the like. In an embodiment, the stakeholder end 104d may include any person, party, business entity, organization, or the like that has an interest in one or more activities, data or the like that is located at, managed, or owned by of one or more of the operator end 104a, the consumer end 104b and the supplier end 104c. The person, party, business entity, organization associated with the stakeholder end 104d may include, for example, a bank. B, stock exchange agent/network, N, a futures exchange agent/network, N, an engineer, E, or the like.

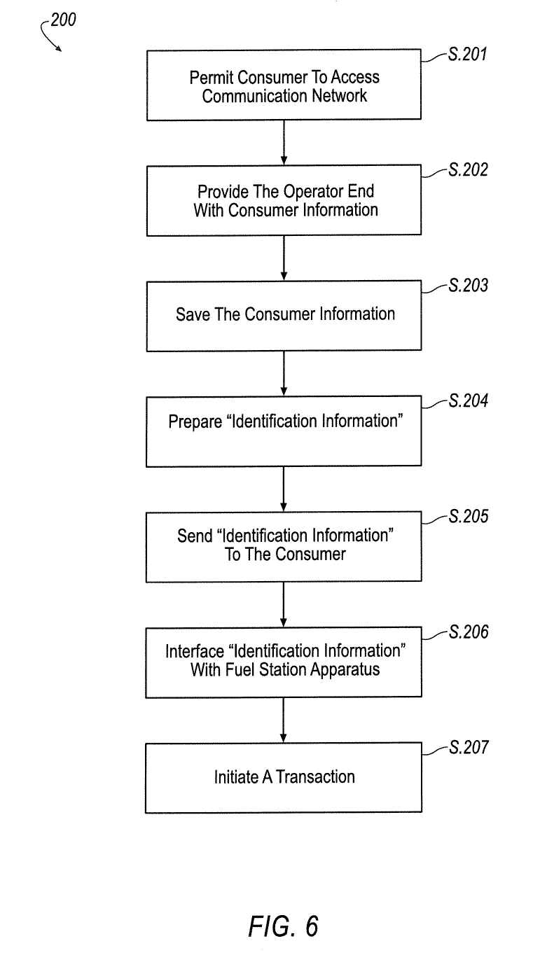

In an embodiment, the communication network 100 may also include several components 106, 108. The components 106, 108 include, but is not limited to an Internet server 106, memory 108 and the like. In an embodiment, the communication network 100 is illustrated to include the Internet server 106 and memory 108 located proximate the operator end 104a. Further, although the communication network 100 is simplified to include one Internet server 106 and one memory 108, as illustrated, it will be appreciated that the communication network 100 is not limited to include one Internet server 106 and memory 108 and that the communication network 100 may include any number and/or type of components to operate the communication network 100, as described in the foregoing methods shown at FIGS. 6-13.

In an embodiment, it will be appreciated that the illustrated Internet server 106 and memory 108 may be located remotely from the physical location of the operator end 104a such that one or more of the server 106 and memory 108 are stored “off site.” It will be appreciated, however, that the illustrated location of the server 106 and memory 108 proximate the operator end 104a is meant to show that there is an association of ownership/management/oversight of the content stored on/controlled by one or more of the server 106 and memory 108 by that of the operator end 104a. Therefore, the embodiment illustrated and describe in FIG. 5 should not be meant to limit the scope of the claimed invention. As such, it will be appreciated that control over, for example, a website and/or the communication/manipulation of data associated with one or more of the server 106 and memory 108 may be governed and controlled by at least the operator end 104a of the communication network 100.

Referring now to FIGS. 6-13, several methods for utilizing/operating one or more of the fuel station apparatus 10 and communication network 100 is described. The logic associated with the steps described in the foregoing methods may be conducted, for example, by a processor, such as, for example, the controller 36 located within a fuel station apparatus 10. However, it will be appreciated that the logic associated with any of the foregoing methods is not limited to being conducted on the controller 36 and that some or all of the logic associated with any of the methods may be conducted, for example, by a processor, controller or the like associated with any device that is located at any of the ends 104a-104d, such as for example, a personal computer, PC, portable communication device, P, or the like. It will also be appreciated that the foregoing methods described in FIGS. 6-13 are embodiments of the invention and do not limit the scope or operation of the invention as described and claimed herein.

Referring to FIG. 6, a method 200 for registering/associating one or more of a consumer, C, and vehicle, V, with the operator end 104a is described. In an embodiment, the consumer, C, or an agent of the consumer, C, may gain access to the communication network 100 at step S.201 and then, at step S.202, send/provide the operator end 104a with consumer information. Also, some consumer information may be automatically collected without requiring consumer input (i.e. distance traveled could be tracked by the consumer, C, or the Operator End 104a, using GPS technology).

The consumer information may include but is not limited to, for example “personal information.” Although changeable at the convenience of the consumer, C, the “personal information” may include but is not limited to the consumer's name, age, address, phone number, credit card/billing information or the like.

Further, in an embodiment, the consumer information may include but is not limited to, for example, “static vehicle information.” The “static vehicle information” may include, but is not limited to the consumer's vehicle brand, vehicle type, engine type/configuration, vehicle model year, vehicle registration number, vehicle fuel tank volume or the like

Further, in an embodiment, the consumer information may include but is not limited to, for example, “dynamic vehicle information.” In an embodiment, operator end 104a may call for the consumer, C, to periodically provide the memory 108 with updated information. Such “dynamic vehicle information” may include, for example, the current vehicle mileage, tire replacement history, tire rotation history, vehicle oil change history, vehicle brake replacement history or the like. It will be appreciated that such information may be useful in determining/calculating fuel economy and the as, as described in the foregoing disclosure at, for example, step S.301e.

Further, in an embodiment, the consumer information may include but is not limited to, for example, “consumer preference/characteristic information.” The “consumer preference/characteristic information” may include but is not limited to consumer driving habit information (e.g., the consumer, C, usually conducts more, less or about the same “stop-and-go”/“city driving” or “substantially constant speed”/“highway driving”) as well as fuel price preference information (e.g., the consumer, C, may or may not have potential sensitivities to price/cost regarding the consumer's likelihood of purchasing “greener,” but more expensive alternative fuels, and the like).

Upon sending the consumer information at step S.202, the consumer information may be saved at the memory 108 at step S.203. Upon saving the consumer information at step S.203, the operator end 104a may optionally prepare “identification information” at step S.204. The “identification information” may include the “personal information,” “static vehicle information,” “dynamic vehicle information,” “consumer preference/characteristic information” or the like. In an embodiment, the “identification information” may be formatted as a code, encrypted data, or the like that is sent, at step S.205, to memory of one or more of the consumer's vehicle, V, personal computer, PC, portable communication device, P, or the like.

In an embodiment, the sending of “identification information” at step S.205 may also include the sending of a program that will selectively, automatically or periodically cause a wireless broadcast of the “identification information” that may be received by, for example, the fuel station apparatus 10. Accordingly, upon bringing one or more of the vehicle, V, personal computer, PC, portable communication device, P, or the like proximate the fuel station apparatus 10, the broadcasting of the “identification information” will result in a “smart,” quick and convenient identification of the consumer, C,/vehicle, V, by the fuel station apparatus 10, which may ultimately result in an expedited transaction between the consumer, C, and the fuel station apparatus 10.

In an alternative embodiment, steps S.204 and S.205 may be conducted in a different manner. Rather than, for example, sending the “identification information” to the vehicle, V, personal computer, PC, portable communication device, P, or the like, the operator end 104a, at step S.204, may manufacture, for example, a magnetized card (e.g., substantially similar to a credit card), RFID tag or the like that contains the “identification information.” The operator end 104a may then mail the magnetized card/RFID tag to the consumer, C, such that the consumer, C, may, for example, locate, place or adhere the RFID tag to the vehicle, V, and/or manually carry the magnetized card on the consumer's person.

Accordingly, if, for example, the RFID tag is adhered to a window of the vehicle, V, the substantially close proximity of the vehicle, V, to the fuel station apparatus 10 may result in a “smart,” quick and convenient identification of the consumer, C,/vehicle, V, by the fuel station apparatus 10. Alternatively, if, for example, the consumer, C, carried the magnetized card on his/her person, the consumer, C, may in/directly engage the magnetized card with the fuel station apparatus 10 in order to initiate a “smart,” quick and convenient identification of the consumer, C,/vehicle, V, by the fuel station apparatus 10.

Accordingly, in view of the above potential means for providing one or more of a consumer, C, vehicle, V, personal computer, PC, portable communication device, P, with the “identification information,” one or more of the consumer, C, vehicle, V, personal computer, PC, and portable communication device, P, may interface the “identification information” with the fuel station apparatus 10 at step S.206. Upon interfacing the “identification information” at step S.206, the fuel station apparatus 10 may initiate a transaction procedure at step S.207.

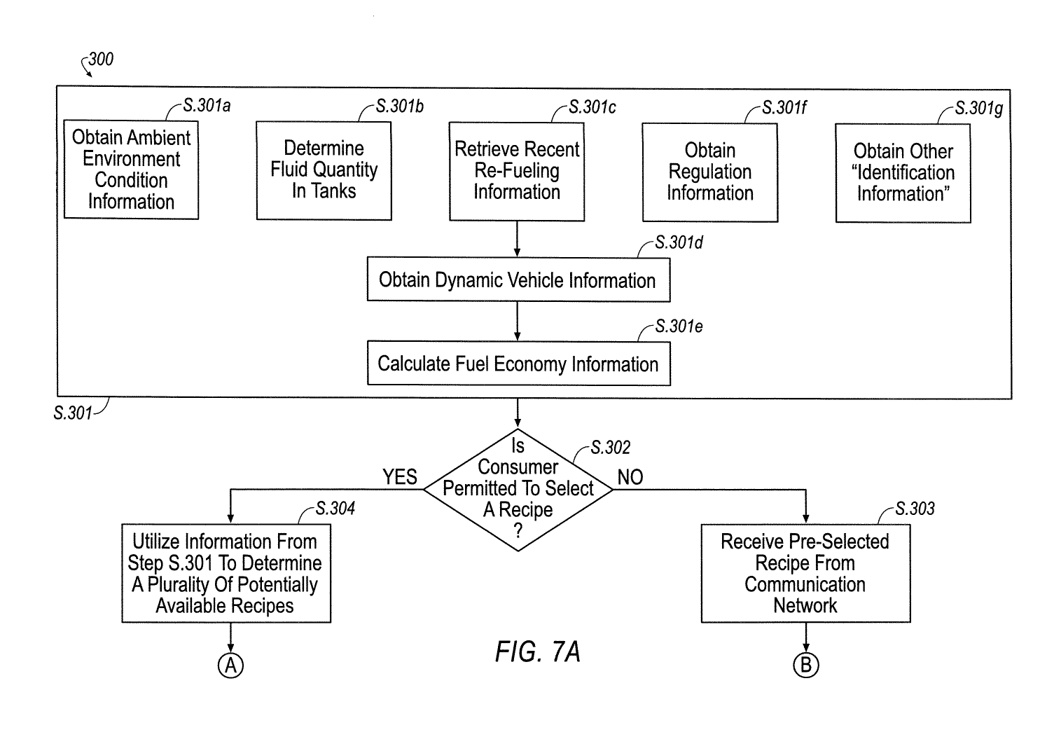

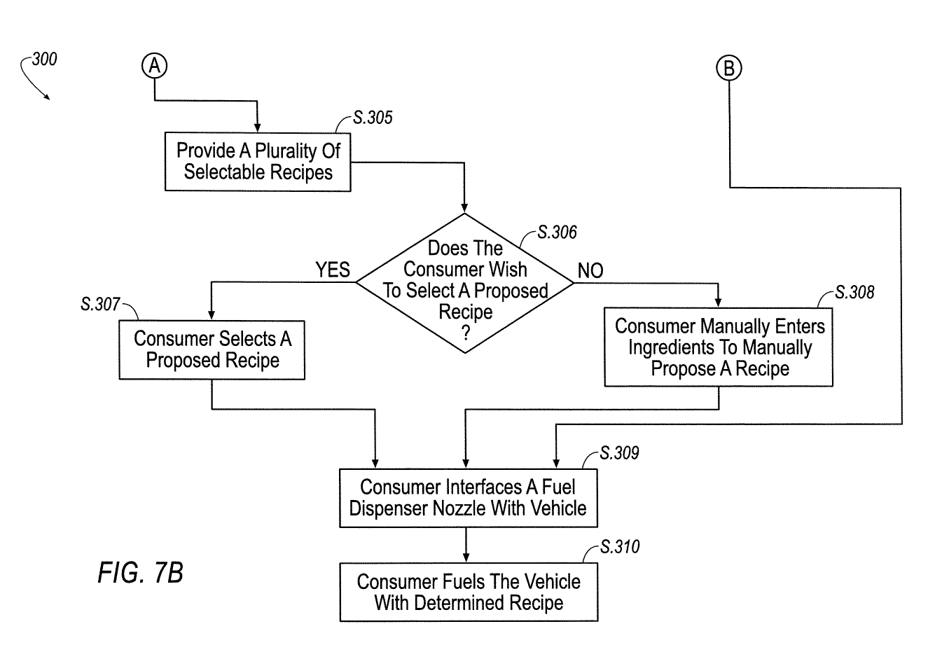

Referring to FIG. 7A, a method 300 for conducting a transaction between the consumer, C, and the fuel station apparatus 10 is disclosed in accordance with an embodiment of the invention. In general, the method 300 includes the consideration of several factors in order to suggest a fluid “recipe” to the consumer, C, that may contained one or more fluids/“ingredients” and blend ratios.

In an embodiment, the method 300 may include the retrieving of data from one or more information resources at step S.301. In an embodiment, step S.301, may include the obtaining of ambient temperature/humidity information from the second temperature sensor 44/second humidity sensor 46 at step S.301a. In an embodiment, step S.301 may include the step S.301b of determining the available quantity of fluid within each of the tanks 34a-34n by causing the controller 36 to query an inventory sensor 82 (see, e.g., FIG. 4) associated with each of the tanks 34a-34n.

In an embodiment, step S.301 may also include the steps of retrieving the most recent re-fueling information at step S.301c, which may be followed by the obtaining of “dynamic vehicle information” at step S.301d, which may be followed by the calculating of fuel economy information at step S.301e. In an embodiment, step S.301 may also include the obtaining of relevant jurisdictional regulation information at step S.301f. In an embodiment, step S.301 may include the obtaining of other “identification information” at step S.301g. Although several sub-steps of retrieving data are identified above at sub-steps S.301a-S.301g, it will be appreciated that the method 300 is not limited to the above-discussed sub-steps and that the method 300 may be practiced with any desirable number/type of sub-steps.

In an embodiment, it will be appreciated that the method 300 may be provided with the provision of restricting the fluid “recipe” selection capabilities of the consumer, C. Such restrictions may arise from, for example, the data retrieved from step S.301f where a jurisdictional regulation is in place to only permit the consumer, C, to retrieve a bio-fuel from the fuel station apparatus that is 100% void of a conventional diesel/gasoline “ingredient.” Such jurisdictional restrictions may arise from diesel/gasoline shortages, emergency rationing requirements, environmental regulations or the like.

Further, in an embodiment, such restrictions may arise from, for example, the data retrieved at step S.301g where, for example, an agent of the consumer, C, wishes to control the selection of a particular “recipe.” In an embodiment, the agent may be, for example, a tractor-trailer company fleet manager, and, the consumer, C, may be, for example, a driver that is contracted to operate a tractor-trailer, V. Accordingly, in an embodiment, the fleet manager may have previously, at step S.202 from FIG. 6, informed that operator end 104a that one, some or all tractor-trailers, V, in his fleet are to only be permitted to utilize a particular fluid “recipe” at a particular time.

It will be appreciated that such selections may be made by the fleet manager for a variety of purposes including, but not limited to: cost-savings purposes (i.e., the tractor-trailer company wants to control costs by forcing its drivers to re-fuel their tractor-trailers with a cheapest alternative fuel blend that is available), fuel economy purposes (i.e., the tractor-trailer company wants to force its drivers to re-fuel the tractor-trailers with an alternative fuel blend that maximizes fuel economy, which may or may not be independent of cost), public-relations purposes (i.e., the tractor-trailer company promotes itself as a “green” company by forcing its drivers to re-fuel their tractor-trailers with a “green” alternative fuel) or the like. As such, when the driver, C, pulls his tractor-trailer up to a fuel station apparatus 10 (e.g., as described above at step S.206), the transaction initiated at step S.207 may be expedited in that the driver, C, does not have to select a particular “recipe” in view of his/her fleet manager's pre-defined selection.

Accordingly, in view of the above, the method 300 may include step S.302 where it is determined if the consumer, C, is permitted to select a fluid “recipe.” If, for example, a selection restriction is in place, the method 300 may be advanced to step S.303 where a pre-selected “recipe” is provided to the fuel station apparatus 10. However, if, for example, no selection restriction is in place, the method 300 may be advanced from step S.302 to step S.304 where the controller 36 utilizes the data gathered from the one or more information resources at step S.301 in order to cause the controller 36 to investigate the potential of preparing one or more “recipes.”

Referring to FIG. 7B, at step S.305, the controller 36 may provide a plurality of potentially selectable “recipes” to the consumer, C. In an embodiment, the display screen 18 may communicate the following, for example, to the consumer, C: “Hello Oliver! It has been determined that you achieved outstanding fuel economy with our previous suggestion of “B17” (i.e. 17% bio feedstock & 83% diesel). Because today's ambient temperature should be a constant 70° F., and, because you have informed us that you anticipate being on the highway for your holiday trip from Detroit, Mich. to Traverse City, Mich. this weekend, we propose that you try a blend of “B21” with a knocks-reducing additive in order to optimize your fuel economy and personal cost of fuel during this re-fueling visit.”

Further, it will be appreciated that the controller 36, at step S.305, may flag/communicate one or more of the potential “recipes” in order to draw the consumer's attention to one or more of the potential “recipes.” For example, in an embodiment as described above, one of the potential “recipes” may be flagged to provide the consumer, C, with an optimized fuel economy.

Further, in an embodiment, it may be flagged/indicated to the consumer, C, at step S.305 that one of the potential “recipes” may be the cheapest of all available potential “recipes.” In some circumstances, if the shelf life on a particular bio-feedstock is about to expire, the fuel station apparatus 10 may alert the consumer, C, that a particular blend may be discounted in order to entice the consumer, C, to purchase and deplete the nearly-expired bio-feedstock material from the fuel station apparatus 10.

Further, in an embodiment, it may be flagged/indicated to the consumer, C, at step S.305 that a particular “recipe” may be the “greenest,” but however, may also be relatively expensive when compared to other available “recipes.” For example, the fuel station apparatus 10 may communicate to the consumer, C, that a “B100” blend may offer the consumer, C, with the “greenest” alternative fuel solution, but, however, the “B100” blend may be prohibitively expensive when compared to other available “recipes” that is/are available from the fuel station apparatus 10.

At step S.306, the method 300 may include the step of querying the consumer, C, if it is desired to select one of the proposed “recipes.” If, for example, the consumer, C, wishes to choose one of the “recipes,” the method 300 is advanced to step S.307 where a proposed “recipe” is selected by the consumer, C.

In some circumstances, it will be appreciated that the consumer, C, may not be willing to select a proposed “recipe” (e.g., the consumer, C, may not be able to afford or does not have a preference for any of the proposed recipes). However, the consumer, C, in such circumstances, may still wish to select an alternative fuel that is still not 100% diesel or gasoline. Accordingly, in an embodiment, if the consumer, C, does not wish to select a proposed “recipe,” the method S.300 may be advanced to step S.308 where the consumer, C, may be permitted to manually input a desired amount of one or more ingredients into the fuel station apparatus 10 by way of, for example, the input keys/buttons 16. For example, the consumer, C, may input a manual selection of 2% bio-feedstock and 98% diesel in order to manually propose a manufacture of a “B2” bio-diesel.

In view of the path selected from steps S.302 or S.306, the method S.300 may be advanced to step S.309 where the consumer, C, retrieves and interfaces the fuel dispenser nozzle 20 with the vehicle, V. At step S.310, the consumer, C, fuels the vehicle, V, with either the pre-selected “recipe” from step S.303, the proposed “recipe” from step S.307, or the manually-created “recipe” from step S.308.

As indicated above, the fuel station apparatus 10 may be provided with fluids that are not considered to be a fuel (e.g., ADBLUE®/AUS32 or the like). However, it will also be appreciated that the fuel station apparatus 10 may also provide a specific class of fluids that may be utilized as a fuel, but, however, are not subject to a state and/or federal tax. Such fuels are usually intended to operate, for example, a refrigeration unit associated with a meat or dairy transporting vehicle.

Because such fuels are exempt from a state and/or federal tax, such fuels are obviously cheaper than vehicular diesel. Such non-taxable fuels may include, for example, refrigerant diesel/“refer-diesel.” Accordingly, it will be appreciated that when taxable, “vehicular”/“road” diesel fuel increases in price, consumers, C, may be more likely to violate the law by filling the fuel tank that is connected to the prime mover of the vehicle, V, with the cheaper, non-taxable diesel fuel in order to save money.

In order to distinguish non-taxable diesel from taxable diesel, a dye/colorant is typically added to the fuel such that a highway officer may easily determine if the prime mover fuel tank of the vehicle, V, has been illegally fueled with the non-taxable diesel fuel. Accordingly, it is not entirely possible to determine if a vehicle, V, has been illegally fueled with a non-taxable fuel without manually inspecting the color of the fuel within the tank connected to the prime mover of the vehicle, V.

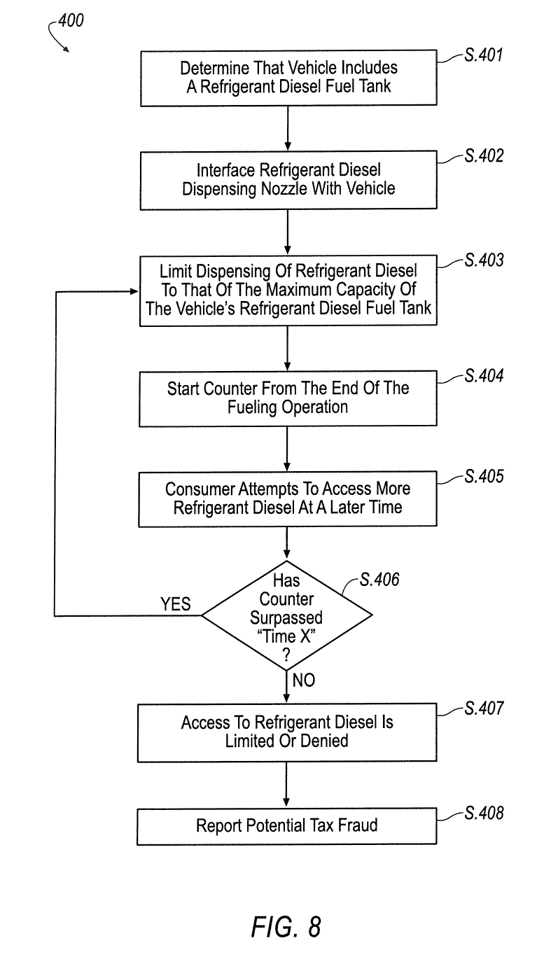

Accordingly, referring to FIG. 8, a method 400 for restricting the quantity of dispensed fluid from the fuel station apparatus 10 is disclosed in accordance with an embodiment of the invention. Although the method 400 is directed to a fluid including a non-taxable diesel fuel, it will be appreciated the method 400 is not limited to a non-taxable diesel fuel and may be directed towards any desirable fluid provided by the fuel station apparatus 10.

In an embodiment, at step S.401, the fuel station apparatus 10 may determine, from information gathered at step S.206, for example, that the vehicle, V, includes a tank that is dedicated to powering a refrigeration unit. Further, in an embodiment, step S.401 may determine the volume of the tank to receive the refrigerant diesel. At step S.402, the consumer, C, retrieves and interfaces the fuel dispenser nozzle 20 with the vehicle, V, for filling the refrigerant diesel tank at step S.403.

Referring to step S.403, if the consumer, C, has attempted to defraud the government by depositing the refrigerant diesel into the prime mover fuel tank of the vehicle, V, the controller 36 may automatically cease the fueling operation once the fuel station apparatus 10 have provided a quantity of refrigerant diesel that is substantially equivalent to the maximum capacity/volume of the refrigerant diesel fuel tank of the vehicle, V.

Accordingly, it will be appreciated that the method 400 may successfully prevent the consumer from “topping off” the prime mover fuel tank with the refrigerant diesel due to the fact that the prime mover fuel tank may include, for example, a 100-gallon capacity whereas the refrigerant diesel tank may include, for example, a 10-gallon capacity. Therefore, a potentially devious consumer, C, may be restricted to filling the prime mover fuel tank.

Further, in an embodiment, the method 400 may be advanced from step S.403 to step S.404 where the filling of the refrigerant diesel is recorded and a time based counter, for example, is started. At step S.404, the counter may be set, for example, to count up to a minimum time when it is anticipated that the refrigerant diesel tank may be depleted. From step S.404, the method may be advanced to step S.405 where the consumer may subsequently access the same or another fuel station apparatus 10 in order to retrieve additional refrigerant diesel. At step S.406, the method 400 may determine if the counter has reached a time (e.g., “Time X”) where the refrigerant diesel should have been depleted. If, for example, the counter has counted to approximately the time when the refrigerant diesel should have been depleted from the tank, the method 400 may be returned to step S.403 where the fuel station apparatus 10 may permit access to the refrigerant diesel.

However, if it is determined at step S.406 that the counter has not yet reached the amount of time when the refrigerant diesel tank should have been depleted, the method 400 associated with the fuel station apparatus 10 may deny the consumer, C, access to the refrigerant diesel. Accordingly, the method 400 may therefore be advanced from step S.406 to step S.407 to provide an indication to the consumer, C, that access to more refrigerant diesel may be restricted or limited to an amount estimated to be consumed for the period of elapsed time, as determined by the counter. In an embodiment, the method 400 may optionally be advanced from step S.407 to S.408 to alert a fleet manager, supervisor, governmental agent or the like of a potential tax fraud by the consumer, C. In such a case, the fleet manager, supervisor or the like, may determine if an independent investigation should be initiated in order to determine if termination or discipline of the employee is warranted.

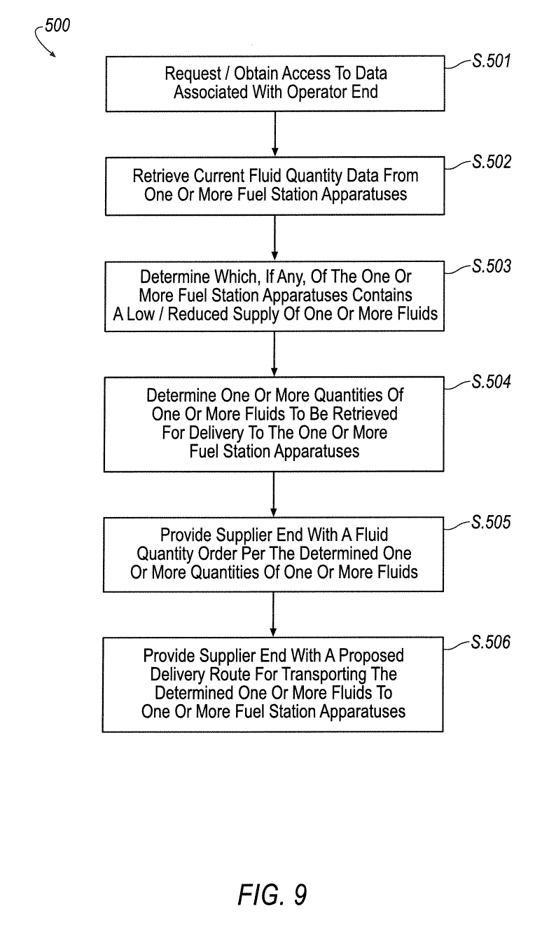

Referring now to FIGS. 9-13, a plurality of methods are discussed that are directed to a variety of novel concepts for utilizing data associated with, but not limited to, the operator end 104a. Referring to FIG. 9, a method is shown generally at 500 in accordance with an embodiment of the invention. In an embodiment, the method 500 is generally directed to the concept of providing a supplier end 104c with information associated with the operator end 104a, such that the supplier end 104c may be aware of and/or optimize the servicing of one or more fuel station apparatuses 10.

In an embodiment, the method 500 may include the step S.501 of requesting/obtaining access to data associated with the operator end 104a. In an embodiment, the supplier end 104c may conduct the requesting/obtaining step S.501. However, it will be appreciated that the step S.501 may alternatively be conducted by the operator end 104a such that access, by the supplier, F, to some or all of the data associated with the memory 108 may be limited or restricted.

In an embodiment, if, for example, the supplier end 104c represents a fluid/fuel supplier, F, one or more of the operator end 104a and the supplier end 104c may be interested in, for example, the inventory/quantities of one or more fluids located at one or more fuel station apparatuses 10. Accordingly, in an embodiment, one or more of the operator end 104a and the supplier end 104c, may desire to retrieve, for example, at step S.502, the current fluid quantity data from one or more fuel station apparatuses 10 from the memory 108.

Accordingly at t step S.503, one or more of the operator end 104a and the supplier end 104c may determine which, if any, of the one or more fuel station apparatuses 10 contain a low/reduced supply of the one or more fluids. Based upon the information determined from step S.503, at step S.504, a total quantity of one or more fluids needed to replace the reduced inventory of the one or more fuel station apparatuses 10 may be determined.

If, for example, the operator end 104a conducts steps S.501-S.504, the operator end 104a may, at step S.505, provide the supplier end 104c with an order according to the determined one or more quantities of one or more fluids from step S.504. As such, if, for example, the operator end 104a is responsible for managing the inventory of the one or more fuel station apparatuses 10, the operator end 104a may limit or restrict the access to the data in the memory 108 by the supplier end 104c. However, it will be appreciated that, if, for example, the supplier end 104c is responsible for managing the inventory of one or more of the fuel station apparatuses 10, the steps S.502-S.504 may be transparent to the supplier end 104c such that upon conducting the accessing step S.501, the supplier end 104c may be immediately provided with “an order” at step S.505 even though the operator end 104a doesn't necessarily, per se, submit an order to the supplier end 104c. In other words, “the order” at step S.505 may also be referred to as a “work order” retrieved by the supplier end 104c in order to determine what amount(s) of fluid(s) will be needed for a later delivery run.

Upon conducting step S.505, the method S.506 may optionally provide the step S.506 of providing the supplier end 104c with a proposed delivery route for transporting the determine one or more fluids to one or more fuel station apparatuses 10. In an embodiment, it will be appreciated that some fluid station apparatuses 10 that are included in a delivery route for a supplier may not include a reduced inventory, and, as such, the supplier may not need to visit one or more of the fuel station apparatuses 10. Accordingly, in order to reduce a waste of time and energy, the efficiency of the delivery operation may be increased by determining which fuel station apparatuses 10 should be visited, when they should be visited, and, what is the best (e.g., the shortest or quickest) route that the supplier should follow.

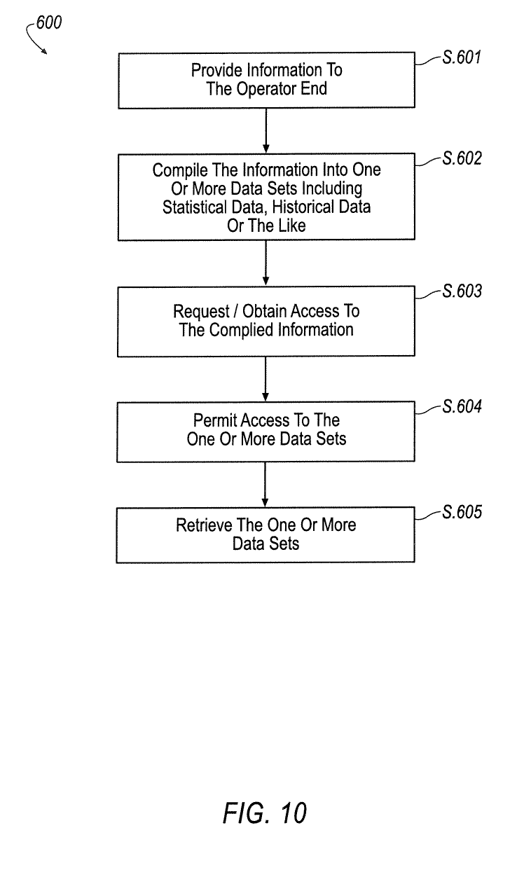

Referring to FIG. 10, a method is shown generally at 600 in accordance with an embodiment of the invention. In an embodiment, the method 600 is generally directed to the concept of providing one or more parties (e.g. a stock/futures exchange, bank, engineer/engineering firm, government entity, or the like) at the stakeholder end 104d with information associated with the operator end 104a.

In an embodiment, the information may include, for example, statistical data, historical data, or the like. In an embodiment, the statistical data, historical data or the like may include but is not limited to, for example, any data that is associated with the “identification information.” Accordingly, the stakeholder end 104d may request and obtain, for example, “personal information,” “static vehicle information,” “dynamic vehicle information,” “consumer preference/characteristic information” or the like. In an embodiment, it may be determined by the operator end 104a to restrict some or all of the provided information. Further, in an embodiment, it will be appreciated that some information, such as, for example, consumer billing information, may be kept strictly confidential.

In an embodiment, a stakeholder at the stakeholder end 104d may include, for example, an engineer, E, that has an interest in seeing what “recipes” are being selected and which “recipes” provide the best fuel economy. Accordingly, with such information in hand, the engineer, E, may use the data in order to advance the arts by creating and testing one or more new “ingredients” and/or “recipes” that are not yet currently being utilized in the field. Further, it will be appreciated that, if, for example, the engineer, E, discovers or suggests a new “ingredient,” “recipe,” or the like, the engineer, E, may elect to share, sell, suggest and/or upload the new “ingredient,” “recipe” or the like to the operator end 104a for subsequent sharing with the consumer end 104a.

Further, in an embodiment, a stakeholder at the stakeholder end 104d may include, for example, a bank, B, a stock/futures exchange, N, or the like. Such institutions, may, for example, have financial interests in, for example, the use/sales of the “ingredients” offered at the one or more fuel station apparatuses 10, and, as such, the institution may request and be provided with uses/sales of the fluids/“ingredients” in order to assist the institutions with investment considerations related to the fluids/“ingredients.” For example, forward buying on one or more futures exchanges. Further, in an embodiment, it will be appreciated that the method 600 may be utilized by the stock/futures exchange, N, in order to conduct steps S.709, S.908 or the like, which are discussed herein.

As seen in FIG. 10, the method 600 includes the step S.601 of providing the operator end 104a with information. As discussed above, the information may include, for example, “identification information.” In an embodiment, the information provided at step S.601 may originate from one, some or all of the consumers, C, that utilize the communication network 100.

At step S.602, as the operator end 104a receives the information, it may be compiled into one or more data sets that include, for example, “statistical data,” “historical data,” or the like. In an embodiment, the statistical data may include, for example, vehicle type data (e.g., vehicles currently utilizing the one or more fuel station apparatuses 10 include 1,513,697 sedans, 498,569 trucks, 389,312 sport utility vehicles and 21,378 tractor-trailers). In an embodiment, the historical data may include for example, fuel economy data (e.g., for “recipe #1,” during the last three months, sedans realize 63 mpg, trucks realize 51 mpg, sport utility vehicles realize 46 mpg and tractor-trailers realize 36 mpg).

At step S.603, the stakeholder end 104d may request/obtain access to the compiled information from step S.602. At steps S.604, S.605 the stakeholder end 104d may then access and subsequently retrieve the one or more data sets for subsequent use of the one or more data sets according to their wants/needs.

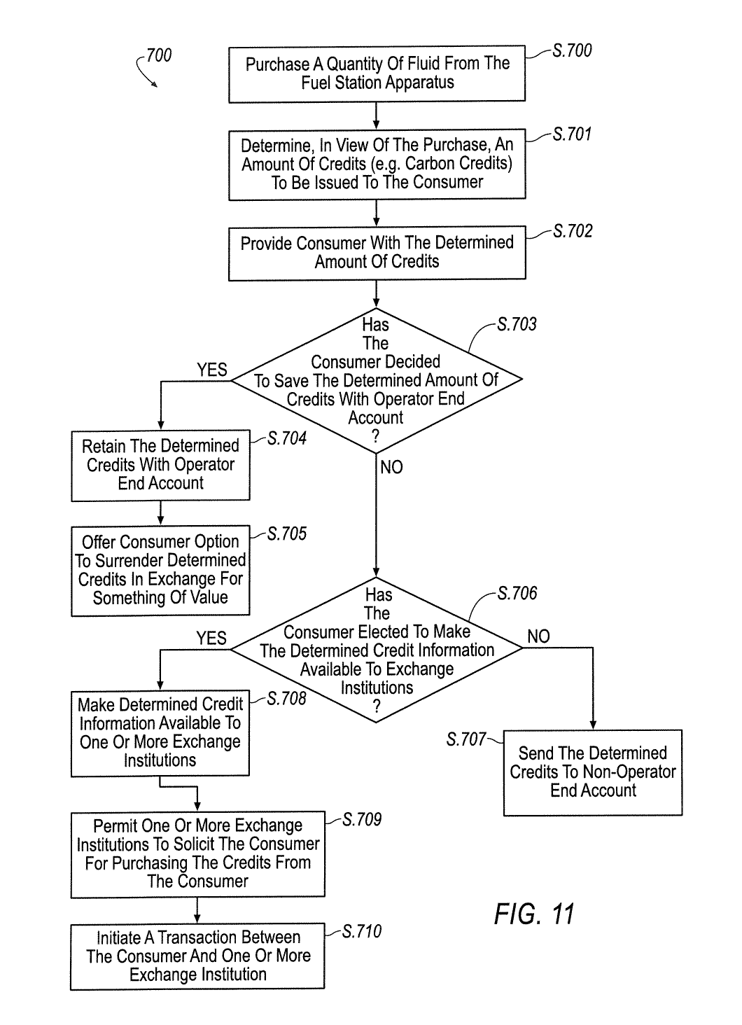

Referring to FIG. 11, a method is shown generally at 700 in accordance with an embodiment of the invention. In an embodiment, the method 700 is generally directed to the concept of providing one or more parties at the consumer end 104b with information associated with the operator end 104b.

In an embodiment, the information that the consumer, C, at the consumer end 104b may desire to retrieve is a “credit” that the consumer, C, has amassed, such as, for example, “carbon credits” by purchasing environmentally-friendly fluids from the fuel station apparatus 10. Such “credits” may ultimately have a monetary value that may be redeemed, sold, traded or the like.

It will be appreciated that although the forgoing description may be directed to “credits” relating to, for example, “carbon credits,” the invention is not limited or restricted to a particular credit. For example, a “credit” may be related to and include any type of data that is associated with, for example, a unit or summed quantity of fluid dispensed from the fuel station apparatus 10. Accordingly, in an embodiment, a “credit,” for example, may include an amount of tax to be paid to a local, state or federal government that may be associated with, for example, a unit or summed quantity of fluid dispensed from the fuel station apparatus 10

Referring now to FIG. 11, step S.700 of the method 700 includes the consumer, C, or an agent of the consumer, C, purchasing a quantity of fluid from the fuel station apparatus 10. Then, at step S.701, it may be determined, in view of the purchase at step S.700, an amount of “credits” to be issued to the consumer, C, agent of the consumer, C, or the like. At step S.702, the consumer, C, agent of the consumer, C, or the like may be provided with the determined amount of credits.

At step S.703, it may be determined if the consumer, C, agent of the consumer, C, or the like has decided to save/“bank” the credits with an operator end account. If it has been decided to save/“bank” the credits, at step S.704, the credits are retained with the operator end account. Optionally, at step, S.705, the operator end 104a may offer the consumer, C, agent of the consumer, C, or the like to surrender the credits in the operator end account in exchange for something of value, such as, for example, money, a free quantity of fluid from the fuel station apparatus 10 or the like.

However, if the consumer, C, agent of the consumer or the like has decided at step S.703 to not save/“bank” the credits with the operator end account, the method may be advanced to step S.706 to determine if the consumer, C, agent of the consumer, C, or the like has elected to send the credits to a non-operator end account at step S.707, or, to make the amassed credit information available to an exchange institution (e.g., a stock/futures exchange, N) at step S.708. It will be appreciated, however, that by making the information available to an exchange institution at step S.708, the credits may still be located or “saved” in an account, such as, for example, the operator end account. Accordingly, at step S.703, it will be appreciated that the term “save” may mean that the consumer, C, has made a conscious decision to keep the amount of credits “off the market” by keeping the amassed credit information secret, whereas, for example, the advancing of the logic to step S.708 results in a decision by the consumer, C, to make such amassed credit information available and “on the market” such that the consumer, C, or agent of the consumer, C, may be solicited at step S.709 by an exchange institution.

At step S.710, if, for example, the consumer, C, or agent of the consumer, C, decides that the solicited offer is agreeable, the consumer, C, or agent of the consumer, C, may decide to initiate a transaction with the exchange institution by relinquishing the credits in exchange for something of value from the exchange institution. However, it will be appreciated that the method 700 is not limited to the consumer, C, or agent of the consumer, C, receiving a solicitation, but, rather, it will be appreciated the consumer, C, or agent of the consumer, C, may solicit one or more exchange institutions such that the consumer, C, or agent of the consumer, C, may initiate a transaction with the one or more exchange institutions.

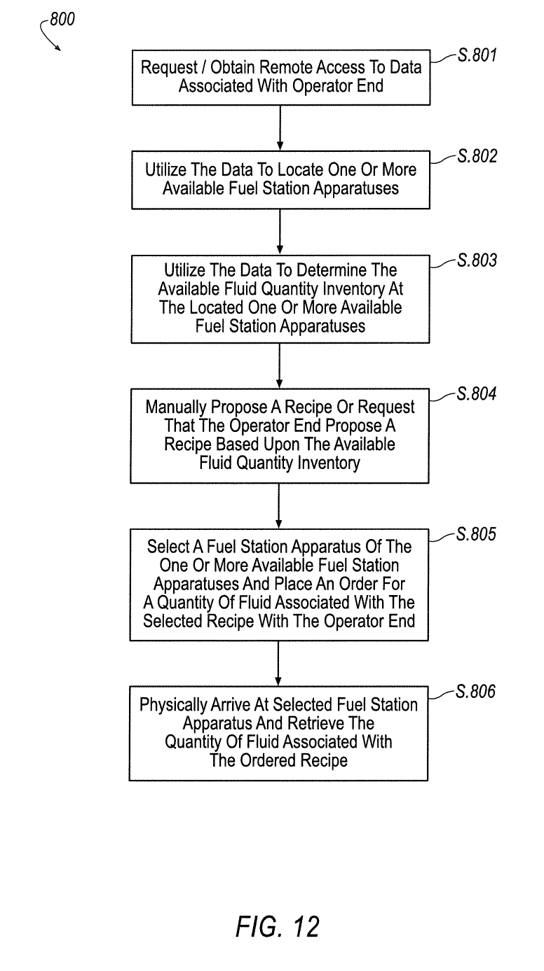

Referring to FIG. 12, a method is shown generally at 800 in accordance with an embodiment of the invention. In an embodiment, the method 800 is generally directed to the concept of providing a consumer, C, or an agent of the consumer, C, remote access to real-time information related to fluid inventory at one or more fuel station apparatuses 10 in order to remotely select a “recipe” from the fuel station apparatus 10 for later retrieval.

At step S.801, the consumer, C, or agent of the consumer, C, may request/obtain remote access to data associated with the operator end 104a. In an embodiment, the consumer, C, or agent of the consumer, C, may be located remotely from or not in close proximity to a fuel station apparatus 10 to conduct step S.801; however, it will be appreciated that the remote/not proximate location is not required to perform step S.801.

In an embodiment, the requested/obtained data may be a real-time determination of a location (see, e.g., step S.802) and/or an available inventory of fluid at one or more fuel station apparatuses 10 (see, e.g., step S.803). In an embodiment, the method 800 may be utilized to determine, for example, price of one or more fluids, or, to determine, for example, if one or more fuel station apparatuses 10 are almost/completely “sold out” of one or more fluids. Accordingly, access to such information may assist the consumer, C, or agent of the consumer, C, in determining which, if any, fuel station apparatuses 10 is/are an optimal one to patronize.

Further, in an embodiment, as shown at steps S.804-S.806, it will be appreciated that the consumer, C, agent of the consumer, C, or the like may manually propose a recipe or request that the operator end 104a propose a recipe based upon the available real-time availability of one or more fluid quantity inventories determined from steps S.802-S.803. At step S.805, the consumer, C, or agent of the consumer, C, may select a fuel station apparatus 10 of the one or more available fuel station apparatuses 10 and place and order for a quantity of one or more fluids associated with a selected recipe with the operator end 104a.

Once step S.805 has been executed, step S.806 may be conducted such that the consumer, C, may arrive at the selected fuel station apparatus 10 and retrieve the remotely ordered/reserved/purchased quantity of fluid associated with the ordered recipe at the operator end 104a. In an embodiment, upon physically arriving at the fuel station apparatus 10, the fuel station apparatus 10 may utilize the “identification information” to recognize the consumer, C, such that the consumer, C, may, for example, be greeted by the fuel station apparatus 10 by thanking the consumer, C, for their remote order/reservation/purchase and then permitting the consumer, C, to immediately start retrieving the remotely ordered/reserved/purchased quantity of fluid associated with the recipe. Accordingly, it will be appreciated that the method 800 may further enhance the “smart” aspect of the fuel station apparatus 10 and reduce the amount of time that the consumer, C, is physically located at the fuel station apparatus 10 by eliminating the local, on-site selection of a recipe prior to retrieving the quantity of fluid.

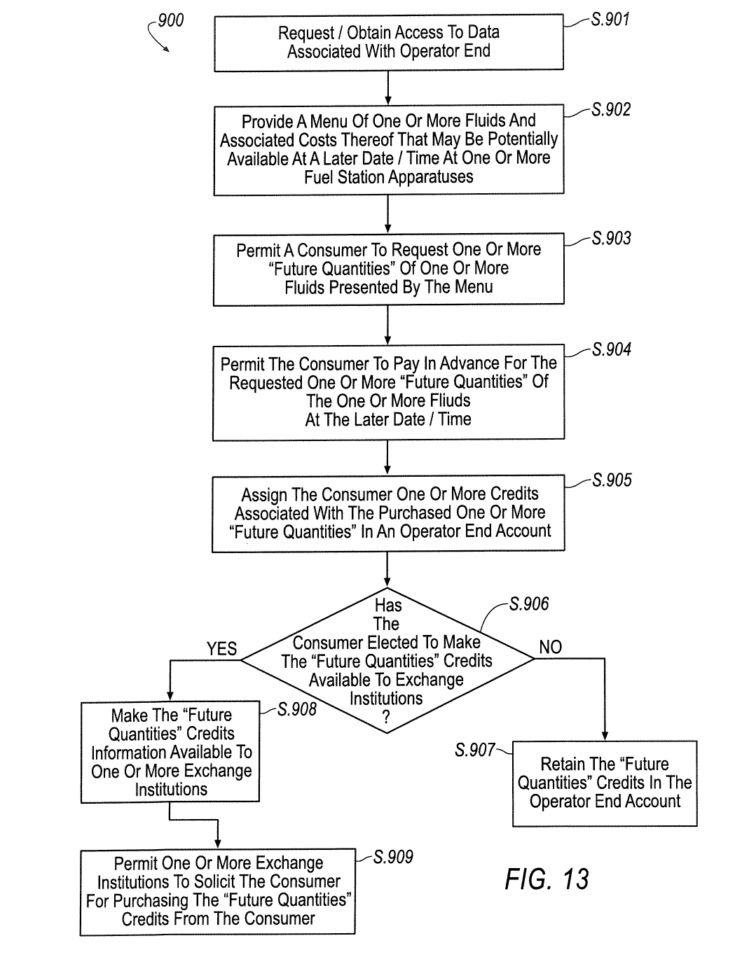

Referring to FIG. 13, a method is shown generally at 900 in accordance with an embodiment of the invention. In an embodiment, the method 900 is generally directed to the concept of providing a consumer, C, or an agent of the consumer, C, with non-real-time/“future” information related to a potential inventory of fluid that may be available/may be made to be available at one or more fuel station apparatuses 10.

In an embodiment, the method 900 may permit a consumer, C, or agent of the consumer, C, to make a current purchase of a quantity of a fluid that the consumer, C, or agent of the consumer, C, may retrieve at a future time. Accordingly, if for example, the method 900 is utilized in such a manner as immediately described above, the consumer, C, will benefit by locking in the current price of a fluid if the price of the quantity of fluid increases at a later time. Further, one or more of the consumer, C, and owner/operator of the fuel station apparatus 10 may benefit by reducing paperwork/billing to the consumer, C, as a result of a single, pre-paid purchase; as such, to entice the consumer, C, to utilize the method 900, the owner/operator may entice the consumer, C, to pre-purchase one or more quantities of fluid by offering the consumer, C, a discount price for the advanced order. Further, the owner or operator of the fuel station apparatus 10 may benefit by the method 900 as immediately described above because the quantity of the one or more fluids may be paid for in advance such that, if, for example, one of the fluids includes an expire-able/perishable bio-feedstock, the owner or operator does not suffer a loss of the pre-purchased fluid inventory if it does not get consumed prior to the expiration date.

Alternatively, the method 900 may be utilized as a “micro-futures” trading methodology that permits the consumer, C, or agent of the consumer, C, to utilize the method 900 as an investment mechanism to purchase one or more potentially available fluids. Accordingly, in an embodiment, if the consumer, C, or agent of the consumer, C, believes that the price of one or more fluids may increase at a later date, the consumer, C, or agent of the consumer, C, may purchase a “futures contract” of an amount of one or more fluids to be delivered at a later date and decide to sell the contract if, for example, the price of the one or more fluids has increased in order to realize a profit.

Although the method 900 may be utilized as an investment mechanism as described above, it will also be appreciated that the consumer, C, or agent of the consumer, C, may purchase a “futures contract” with the intention consuming the one or more fluids at one or more later dates/times. Accordingly, in an embodiment, if the consumer, C, purchases too much fluid, or, for example, reduces their driving habits such the consumer, C, does not consume the anticipated amount of one or more fluids recited in the “future contract,” the consumer, C, or agent of the consumer, C, may decide to sell off the amount of the one or more fluids that were not consumed or utilized.

Referring now to step S.901, the consumer, C, or agent of the consumer, C, may request/obtain access to data associated with the operator end 104a. In an embodiment, as described above, the data may include, for example, a menu of one or more potentially available fluids as well as one or more prices/costs of the fluids that may be available/may be made to be available at one or more fuel station apparatuses 10 at one or more later dates/times. Accordingly, the menu and costs may be provided to the consumer, C, or agent of the consumer at step S.902.

Then, at step S.903, the consumer, C, or agent of the consumer, C, may be permitted to request one or more “future quantities” of one or more fluids presented by the menu. Then, at step S.904, the consumer, C, or agent of the consumer, C, may be permitted to pay in advance for the requested one or more “future quantities” of the one or more fluids at the one or more later dates/times.

Then, at step S.905, the consumer, C, or agent of the consumer, C, may be assigned one or more credits associated with the purchased one or more “future quantities.” In an embodiment, the one or more credits may be stored in account that is located, for example, at the operator end 104a. In an embodiment, the one or more credits may be assigned a value, such as, for example, an amount of the one or more fluids, that may be measured in, for example, a gallon, liter or the like. In an embodiment, the operator end 104a may issue an expiration date of the one or more credits, or, for example, permit the consumer, C, or agent of the consumer, C, to retrieve the one or more credits at the consumer's convenience.

At step S.906, the consumer, C, or agent of the consumer, C, may elect to make the one or more “future quantity” credits available to an exchange institution (e.g., a stock/futures exchange). In an embodiment, if, for example, the consumer, C, or agent of the consumer, C, has elected to not make the one or more “future quantity” credits available, the method 900 may be advanced to step S.907 where the one or more credits are kept secret from such institutions in the consumer's account. Alternatively, if the information is made available to an institution, the method 900 may be advanced from step S.906 to step S.908 where the one or more credit information is made available to one or more exchange institutions. Then, at step S.909, the method 900 may permit one or more of the consumer, C, and exchange institutions to solicit and/or initiate a transaction with the other.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. An apparatus, comprising:
a housing;
one or more fluid tanks disposed within the housing;
a fluid modification network in fluid communication with the one or more fluid tanks;
one or more dispenser nozzles each including a hose that is connected to and in fluid communication with the fluid modification network; and
a controller connected to fluid modification network.

2. The apparatus according to claim 1, wherein the fluid modification network includes:
one or more devices, wherein one or more of the devices are connected to the controller, wherein the one or more devices include
one or more valves,
one or more pump-motor devices,
one or more heat exchangers, and
one or more fluid mixers.

3. The apparatus according to claim 2, wherein the controller provides:
means for
controlling the opened/closed orientation of the one or more valves, and
controlling the speed of one or more pump-motor devices for drawing one or more fluids from the one or more fluid tanks.

4. The apparatus according to claim 3, wherein the controller further provides:
means for controlling the operability of the one or more heat exchangers for
manipulating the temperature of the one or more fluids drawn from the one or more fluid tanks.

5. The apparatus according to claim 3, wherein the controller further provides:
means for controlling the operability of the one or more fluid mixers for
mixing two or more fluids of the one or more fluids drawn from the one or more fluid tanks.

6. The apparatus according to claim 1, including one or more sensors connected to the controller.

7. The apparatus according to claim 6, wherein the one or more sensors include one or more of:
a temperature sensor and a humidity sensor located within, or, to the exterior of the housing, wherein one or more of the temperature sensor and the humidity sensor provide
means for determining one or more environmental condition within, or, to the exterior of the housing.

8. The apparatus according to claim 6, wherein the one or more sensors include:
a temperature sensor connected to more of the one or more fluid tanks, wherein the temperature sensor provides
means for determining a temperature of a fluid disposed in the one or more fluid tanks.

9. The apparatus according to claim 6, wherein the one or more sensors include:
an inventory sensor connected to one or more of the one or more fluid tanks, wherein the inventory sensor provides
means for determining a quantity of fluid disposed in the one or more fluid tanks.

10. The apparatus according to claim 1, further comprising:
one or more communication devices connected to the controller.

11. The apparatus according to claim 10, wherein the one or more communication devices include:
an operator interface including one or more input keys/buttons and a display screen, wherein the operator interface provides
means for permitting a user to directly interface with the apparatus.

12. The apparatus according to claim 10, wherein the one or more communication devices include:
an antenna connected to a transmitter/receiver, wherein the antenna provides means for permitting a user to indirectly interface with the apparatus.

13. The apparatus according to claim 1, wherein the one or more fluid tanks includes
means for storing one or more of an aqueous urea solution, a non-fossil-fuel fuel and a fossil-fuel fuel.

14. The apparatus according to claim 13, wherein the means for storing one or more of the aqueous urea solution and the non-fossil-fuel fuel includes
a steel body including an epoxy-glass resin inner liner layer.

15. The apparatus according to claim 13, wherein the means for storing one or more of the aqueous urea solution and the non-fossil-fuel fuel includes
a stainless steel body.

16. The apparatus according to claim 13, wherein the means for storing one or more of the aqueous urea solution and the non-fossil-fuel fuel includes
a high density polyethylene body.

17. The apparatus according to claim 13, wherein the means for storing fossil-fuel fuel includes
a body including plastic blended with a sulfur powder.

18. The apparatus according to claim 13, wherein the means for storing fossil-fuel fuel includes
a body including plastic that is gaseously-sulfonated.

19. A method for operating an apparatus, comprising the steps of:
receiving, at an operator end, consumer information;
preparing identification information in view of the received consumer information;
receiving, at a consumer end, the identification information;
utilizing the identification information for recognizing a consumer or vehicle at the apparatus prior to initiating a transaction.

20. A method for operating an apparatus, comprising the steps of:
retrieving data from one or more information resources;
utilizing the retrieved data for proposing one or more available fluid recipes;
permitting a selection of at least one of the proposed one or more available fluid recipes; and
selecting the at least one of the proposed one or more available fluid recipes.

21. The method according to claim 20, wherein, prior to the utilizing step, further comprising the step of:
determining if a user is permitted to select a proposed one or more available fluid recipes, and, if the user is not permitted to select a proposed one or more available fluid recipes,
receiving a pre-selected recipe for the user.

22. The method according to claim 20, wherein, responsive to the proposing one or more available fluid recipes step, further comprising the step of:
permitting a user to manually propose a fluid recipe for subsequent selection of the manually proposed fluid recipe.

23. The method according to claim 20, wherein the retrieving data step includes the step of:
obtaining one or more ambient environment conditions.

24. The method according to claim 20, wherein the retrieving data step includes the step of:
determining a quantity of fluid in one or more fluid tanks within the apparatus.

25. The method according to claim 20, wherein the retrieving data step includes the step of:
retrieving historical fueling information of a vehicle,
obtaining dynamic vehicle information of the vehicle, and
calculating fuel economy of the vehicle.

26. The method according to claim 20, wherein the retrieving data step includes the step of:
obtaining jurisdictional regulation information.

27. A method for operating an apparatus, comprising the steps of:
determining a current volume capacity of a fluid tank of a vehicle;
limiting a dispensing of an amount of fluid to that of the determined volume of the fluid tank;
determine that a request for an amount of fluid greater than that of the determined volume has been requested; and
limit or deny access to the amount of fluid greater than that of the determined volume.

28. The method according to claim 27, wherein, after the determining an amount step is conducted, further comprising the steps of:
dispensing fluid into the fluid tank,
starting a counter, and
associating a time that the counter has determined with an amount of fluid depleted from the fluid tank for subsequently limiting later dispensing of fluid into the fluid tank to that of the amount consumed.

29. The method according to claim 27, further comprising the step of:
reporting a potential tax fraud to one or more authorities responsive to the denying access of the amount of fluid step.

30. The method according to claim 27, wherein the fluid includes non-taxable, refrigerant diesel.

31. A method associated with the operation of the fluid station apparatus, comprising the steps of:
retrieving current status of the quantity of remaining fluid information in one or more tanks of one or more apparatuses;
determine one or more amounts of fluid to be delivered to the one or more tanks of the one or more apparatuses;
determine a proposed delivery route for delivering the one or more amounts of fluid to the one or more tanks of the one or more fluid station apparatuses.

32. The method according to claim 31, further comprising the step of:
requesting, from a supplier end, one or more of the retrieved fluid quantity information, the determined one or more amounts of fluid information and the delivery route information.

33. The method according to claim 31, further comprising the step of:
sending, to a supplier end, one or more of the retrieved fluid quantity information, the determined one or more amounts of fluid information and the delivery route information.

34. A method associated with the operation of an apparatus, comprising the steps of:
receiving driver, consumer and/or vehicle information at an operator end;
compiling the provided information into one or more data sets;
permitting access by another to the one or more data sets;
sending the one or more data sets to the another that has permitted access.

35. The method according to claim 34, wherein the one or more data sets includes statistical data and/or historical data of one or more of a driver, consumer, and/or vehicle information.

36. The method according to claim 34, wherein the another includes one or more of a banking institution (B), a stock exchange agent/network (N), a futures exchange agent/network (N) and an engineer (E).

37. A method associated with the operation of an apparatus, comprising the steps of:
determining one or more credits to be issued to a consumer in view of an amount of fluid transferred to the consumer;
issuing the one or more credits to the consumer; and
providing the consumer with an ability to relinquish the issued one or more credits to another.

38. The method according to claim 37, wherein the providing step includes the step of offering the consumer with an opportunity to surrender, exchange, sell, trade or donate the issued one or more credits.

39. The method according to claim 37, wherein the providing step includes the step of exchanging the issued one or more credits with an operator end in return for one or more of a monetary credit on a bill to the consumer and a fluid credit including a quantity of fluid to be retrieved by the consumer at a subsequent fluid retrieval operation.

40. The method according to claim 37, wherein the providing step includes the step of the consumer surrendering the issued one or more credits to a stakeholder end in return for the consumer receiving one or more of a monetary credit, a stock credit and a futures credit from the stakeholder end.

41. The method according to claim 37, wherein the providing step includes the steps of:
making the issued one or more credits information available to one or more exchange institutions; and
permitting one or more of the consumer and the one or more exchange institutions to solicit the other for surrendering, exchanging, selling, trading or donating the issued one or more credits.

42. The method according to claim 41, further comprising the step of:
initiating a transaction between the consumer and the one or more exchange institutions that includes at least the step of
the consumer surrendering the issued one or more credits to the one or more exchange institutions.

43. The method according to claim 37, wherein the issued one or more credits include:
one or more nationally recognized or internationally recognized environmental credits.

44. The method according to claim 43, wherein the one or more nationally recognized or internationally recognized environmental credits include:
carbon credits.

45. A method associated with the operation of an apparatus, comprising the steps of:
receiving a selection of a fluid recipe for an apparatus from a consumer end that is remote from said apparatus; and
sending the remote selection to the apparatus for
permitting a consumer to locally retrieve a quantity of fluid related to the remotely-selected fluid recipe.

46. The method according to claim 45, further comprising the step of:
requesting that the operator end propose one or more recipes based upon, at least, the real-time data; and
selecting at least one of the proposed recipes.

47. The method according to claim 45, further comprising the step of:
manually entering, from the consumer end, a recipe based upon, at least, the real-time data; and
selecting the manually entered recipe.

48. The method according to claim 45, wherein the real-time data includes one or more available quantities and prices of one or more fluids that are available at one or more apparatuses.

49. A method associated with the operation of the apparatus, comprising the steps of:
providing a menu of one or more prices related to one or more fluids ingredients that are not available for immediate retrieval from one or more apparatuses;
receiving a selection of one or more quantities of one or more fluid ingredients provided by the menu; and
issuing one or more credits to a consumer for the selection of the one or more quantities of one or more fluid ingredients.

50. The method according to claim 49, further comprising the step of:
providing the consumer with an ability to relinquish the issued one or more credits to another.

51. The method according to claim 50, wherein the providing step includes the step of offering the consumer with an opportunity to surrender, exchange, sell, trade or donate the issued one or more credits.

52. The method according to claim 50, wherein the providing step includes the step of the consumer surrendering the issued one or more credits to a stakeholder end in return for the consumer receiving one or more of a monetary credit, a stock credit and a futures credit from the stakeholder end.

53. The method according to claim 50, wherein the providing step includes the steps of:
making the issued one or more credits information available to one or more exchange institutions; and
permitting one or more of the consumer and the one or more exchange institutions to solicit the other for surrendering, exchanging, selling, trading or donating the issued one or more credits.

54. The method according to claim 53, further comprising the step of:
initiating a transaction between the consumer and the one or more exchange institutions that includes at least the step of
the consumer surrendering the issued one or more credits to the one or more exchange institutions.

55. The method according to claim 49, wherein the issued one or more credits include:
one or more futures contracts for the one or more quantities of one or more fluid ingredients.
